(19) United States
(12) Patent Application Publication
(10) Pub. No.: US 2011/0060628 A1
(43) Pub. Date: Mar. 10, 2011

(54) METHOD FOR ASSESSING CANDIDATES BY VOTING AND A SYSTEM INTENDED FOR THIS PURPOSE AND A PROGRAM PRODUCT COMPRISING A COMPUTER-READABLE MEDIUM

(75) Inventor: Olaf STOERMER, Hamburg (DE)

(73) Assignee: Olaf STOERMER, Hamburg (DE)

(21) Appl. No.: 12/875,528

(22) Filed: Sep. 3, 2010

(30) Foreign Application Priority Data
Sep. 3, 2009 (DE) 10 2009 039 867.8

(51) Int. Cl. G07C 13/00

(52) U.S. Cl. 705/12

(57) ABSTRACT

A method for assessing candidates includes authorizing a plurality of voters to vote for a candidate among a plurality of candidates so as to determine a candidate ranking; determining a weighting for one of a voter and a candidate as a function of a ranking of the candidate or voter during the voting; allocating the weighting to the respective voter or candidate; and changing at least one of the candidate ranking and voter ranking according to the allocated weighting.

### CROSS REFERENCE TO PRIOR APPLICATION

Priority is claimed to German Application No. DE 10 2009 039 867.8, filed Sep. 3, 2009, the entire disclosure of which is incorporated by reference herein.

### FIELD

The invention relates to a method for assessing candidates, in particular in voting competitions in mass media, in which voters authorised to vote determine a candidate ranking of a plurality of candidates or a favourite based on respective voting. The invention further relates to a system for assessing candidates and a program product comprising a computer-readable medium having a computer program logic recorded thereon which is used to assess candidates.

### BACKGROUND

In the media there is a virtually innumerable range of events in which consumers, viewers, users, people or groups of people, referred to hereinafter as “voters”, can vote on candidates, such as content or individuals, for selection or assessment. Hereinafter, the term “candidate” will therefore include individuals as well as objects, parties, animals, intangible objects or the like.

Although these voting procedures sometimes have quite different regulations, in all cases the contents to be voted on, such as songs or individuals, for example actors, are placed in a ranking at the end of the procedure according to the votes cast for them. At the very least this results in a winner or favourite being determined.

For evaluation, the votes are added up, for example as a number of inputs on the Internet or received texts (SMS), telephone calls or the like.

The prior art for conventional voting competitions comprises for example programs and systems, known as voting and contest systems, for recording and processing votes and optionally for configuring and carrying out voting competitions. These also include the technical solutions which aim to digitise the political democratic voting process in the course of e-voting. Further, there are suppliers of voting systems which are used in major events, such as the known TED system for example.

As well as innumerable system developers, who offer voting solutions written in many computer languages, some suppliers of voting or contest systems who aim to stimulate user activity for entertainment purposes can also be identified.

Within the entertainment programmes known as contest/voting competitions, directed towards the end user, in the media and the associated technical systems, there is a very wide range of programme formats. Examples include the known TV formats “Deutschland sucht den Superstar” and “Germany's Next Top Model”.

The history of democratic regulations and mathematical methods for determining voting results goes back to antiquity. For example, social choice theory deals with group decisions by an aggregation of individual preferences to form a collective preference in the form of votes and elections, and with the resulting problems and paradoxes and the prevention, likelihood and resolution thereof.

Existing commercial selection procedures rely on achieving fairness and meaningfulness in the voting results in that for example each voter has precisely one or more equally weighted votes, analogously to some modern political voting procedures, or multiple voting is accepted as a distortion or restricted by regulations.

As a result, however, these known commercial selection procedures always either have a low activation potential for each voter, if he can only vote once, or do not exploit this potential fully over the whole of the addressed target audience, because multiple voting by some voters rapidly leads to other voters losing interest.

However, such voting procedures are not necessarily connected with a possibility of winning. Thus, for example, non-US-citizens worldwide were able to identify their personal favourite for the highest US office. Many thousands of people took part in the Internet vote, even though it had no effect on the actual outcome of the US presidential election.

### SUMMARY OF THE INVENTION

An aspect of the invention on the one hand provides a possibility for making voting competitions of this type of greater interest to the voters, and simultaneously provides an additional economically viable advantage for affiliated partners. Another aspect of the invention provides a system for assessing candidates and a program product comprising a computer-readable medium having a computer program logic for assessing candidates recorded thereon.

Thus, according to the invention, during voting the voter and/or the candidate are allocated points which are determined as a function of the rank of the candidate and/or the voter.

The allocation of points at the time the vote is cast is dependent on rank. This rank may be the rank of a candidate or the rank of a voter or even a combination thereof, in particular only for the candidate, only for the voter, or for both.

The invention is thus based on the finding that the entertainment value and the excitement of the voting competition can be promoted particularly successfully in that during voting, one or more points, which for instance are not constant but depend on the rank already achieved, are allocated to the candidate and/or the voter. Thus, in particular, the gain becomes smaller and smaller as higher ranks are achieved, whilst the initial voting, because of the associated initially lower positions, leads to a particularly strong improvement, so as to stimulate the readiness of the voter to act. Since the ranking is updated regularly, in particular at predetermined constant intervals, this results in a good dynamic for the voters, but also for the viewers, which also leads to strategic considerations in the voting.

In this context, it is particularly advantageous for points which are determined for the candidate from its rank and for the voter from his rank and the rank of his selected candidate to be allocated to the voter and the candidate during voting. To put it more simply, a large number of points are acquired if both the candidate and the voter selecting it are to be found at low ranks in the respective rankings, whilst conversely only a few points can be acquired when voting for preferred candidates occupying the high ranks in the ranking.

In particular, the points allocated to the voter and the candidate during voting are determined as a function of the respective rank in such a way that a higher-placed voter and a higher-placed candidate are allocated fewer points during voting than a lower-placed voter and a lower-placed candidate respectively.

Preferably, in addition to the determination of the candidate ranking of different candidates and/or the favourite, a voter ranking of voters is determined, and is determined as a common ranking for all of the voters or separately for individual candidates in the form of a matrix. This results for example in a voter ranking of voters based on the individual voting, resulting in a matrix which, in addition to the candidate ranking which is the purpose of the voting, also reproduces the associated ranking sequences as a voter ranking of voters.

This basically provides a substantial additional advantage via two constituents, namely via the functions and properties directed towards the voters, in what is known as the front end, and via the functions and properties directed towards the host of voting competitions and its partners, in what is known as the back end. The initially produced variability in the linear or logarithmic rank/point function, for example, optionally taking caps into account, as a function of user activity, provides an improvement in stimulation. In this way a method is initially provided which makes it possible to determine point logics which are optimal for stimulation or which improve stimulation. In this case, the method not only provides the freedom to vary the right to vote and the effect thereof, but also takes into account the activity of the voter in that according to a preferred embodiment of the method, the right to vote is determined based on individual voter-based activity parameters of the respective voter.

The individual influence of the voter on the outcome of the vote is thus established using the individual activity parameter by means of corresponding voting rights, the voter being authorised by partners to cast another vote.

In this way, multiple votes are no longer merely a desirable act which is transparent for all participants, but they also simultaneously make it possible to activate the whole range of participants in terms of their individual readiness to act, since the possibility of winning remains transparent even in the case of low activity and always remains present at first. This means that even later entries into the voting competition still have a sufficient prospect of winning. The aim is thus to obtain sensible voting results in spite of different voting frequencies even when there are large volumes of votes.

Because the individual activity parameter is determined by each voter himself, each voter can develop his own strategies. It can thus also be provided that during the competition the necessary activity by the voter to acquire further voting rights increases linearly or exponentially.

Casting the vote for a candidate initially leads to an improvement in the point rating of the voter. The speed of the increase is rank-dependent and takes place rapidly at first and then only at a decreasing speed, taking into account simultaneously the voting behaviour of other voters at the lower ranks.

There is the option of allowing the competition to appear, to consumers who access the competition via a partner's web page, so as to be discernible or indiscernible as a competition hosted by yet other partners. This results in a ring of partner sites which offer a connection to the same voting competition. The costs of the competition can thus be distributed amongst all of the partners, without the quality of the competition being reduced from the point of view of the individual partners. In this way, the participating partners can benefit from a voting competition provided at low costs and having content relevant to their consumers.

Further, it is particularly advantageous for the individual activity parameters of the voter to be changed based on the intensity of contacts with the partner, in such a way that the voter can therefore in effect collect activity points or new voting rights. Voting rights may for example be acquired by visits to and activity on partner sites, without the low quality of extreme users being involved.

The availability of partner sites to the respective voter, along with a corresponding possibility of controlling the allocation of voting rights, is determined by a pool control system. For this purpose, criteria such as user activity, user profile, and also the origin, blacklists and profile of the partner site may be brought into play. On average, the method according to the invention makes it possible for each participating partner correspondingly to obtain many new visitors on a multiplicative scale, since on average, each user who is obtained via a partner site will be prepared to explore more than one further site to acquire voting rights. It can thus be expected that the original partner will obtain correspondingly many “external” visitors in return.

In this case it is particularly expedient in practice for the individual activity parameter to be influenced by the voter himself when the voter visits a virtual platform of the partner and confirms content, in particular items of information. For this purpose, electronic computing devices, mobile and landline telephones, other Internet-capable devices and any type of manually or electronically operated counting machine, which make it possible to record contributed votes and allocate them to voting content or candidates and to voters casting votes, may be used. On the other hand, electronic output devices according to the invention, which make it possible to display statuses of voting competitions textually or graphically, but moreover television and radio devices and printed matter may also be used. All the aforementioned input and output devices, which make optical or acoustic reproduction possible, have an interface for connection to an arithmetic unit in a communications network available for data transmission for this purpose.

The fact that the candidate ranking and the voter ranking are represented in such a way that they can be identified and even followed by other voters results in an active competition even in relation to the voter ranking.

Moreover, in addition a partner ranking of the partners selected by the voter or a plurality of voters is also produced, in such a way that there is also a competition amongst the partners and as a result an increased effort to make contact with the voters.

Naturally, the incentive to participate in the competition can be further increased in that at least one voter is allocated a win based on the voter ranking of the voters, the tangible or intangible win preferably having a reference to a partner.

Further, in an embodiment, a system for assessing candidates, in particular in voting competitions carried out by mass media such as television, comprises:
an input unit for authorised voters to cast votes;
a communications unit for recording and establishing activity parameters of the voters;
an output unit for displaying a candidate ranking of a plurality of candidates and/or a favourite;
an output unit for displaying a voter ranking of voters.

This stimulates the activity of the consumers as voters and their readiness to vote. Further, public loyalty is maintained by stimulating the attention of participants and viewers over the course of the competition. Moreover, the perception potential in particular of the voters is raised, and the readiness of participants and viewers to investigate the commercially viable content of the host or its partners—generally advertisers—is increased. Further, the coverage of one's own content is increased by the direct response of the consumers in one's own channel before, during and after the voting competition.

Moreover, in an embodiment a program product comprises a computer-readable medium and a computer program logic recorded thereon which is used to assess candidates, in particular in voting competitions at major events, having an output unit for displaying a candidate ranking of a plurality of candidates or a favourite, which comprises a communications unit for recording the vote of the voter in connection with his rank in a voter ranking and/or the candidate's rank in a candidate ranking and an output unit for displaying the candidate ranking of a plurality of candidates and/or a favourite and the voter ranking of voters.

For this purpose, the host uses a web-based hosted service to set up a voting competition by content and regulation and to make it accessible using a plug-in or what is known as a frame or banner on its site. This makes it possible to enter partnerships to carry out voting competitions without having to make direct contact. In this case, the host supplies the prize or prize money. The host determines in the system whether and in what form co-hosts and/or partners can be added to its voting competition. Co-hosts can affiliate themselves with voting competitions available in the system and can also link to these on their sites. The co-hosts contribute to the costs of the prizes or to the prize money and may take part openly or secretly.

The partners may take part as source partners or as target partners. Source partners can also affiliate themselves with available voting competitions and link to these on their websites. However, they do not contribute to the costs of prizes or to the prize money and therefore pay higher participation fees.

The target partners can be linked as providers from whom voting rights can be obtained, without themselves presenting a voting competition on their site. Instead, these target partners merely require a frame for activating the voting right via a corresponding return link. This partnership is predominantly advantageous for those partners who do not wish to appear, to users who are averse to voting, as sites which provide votes, but nevertheless wish to profit from the incoming user-stream from the user-pool.

### BRIEF DESCRIPTION OF THE DRAWINGS

The invention permits various embodiments. For further clarification of the basic principle of the invention, one of these is shown in the drawings and will be described hereinafter. In the drawings, in each case in a schematic diagram:

FIG. 1 shows a voting matrix, which is to be generated by the method according to the invention, for a voting competition;

FIG. 2 shows the sequence for generating the voting matrix;

FIG. 3 shows the connection of the input and output units of the system for carrying out the voting competition;

FIG. 4 shows a procedure for obtaining voting rights for voting competitions.

### DETAILED DESCRIPTION

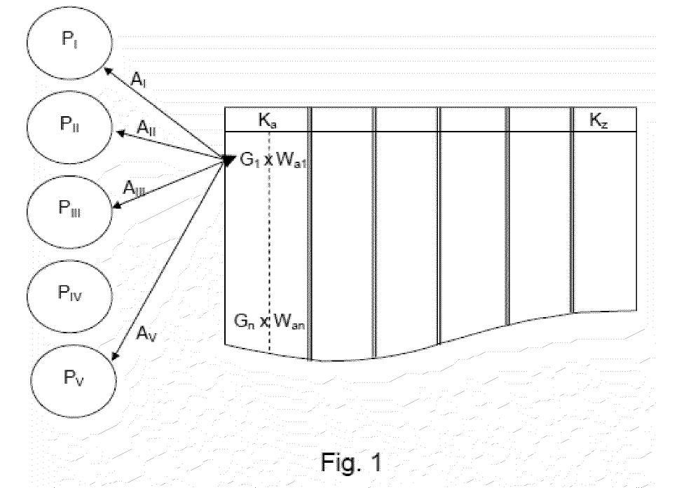

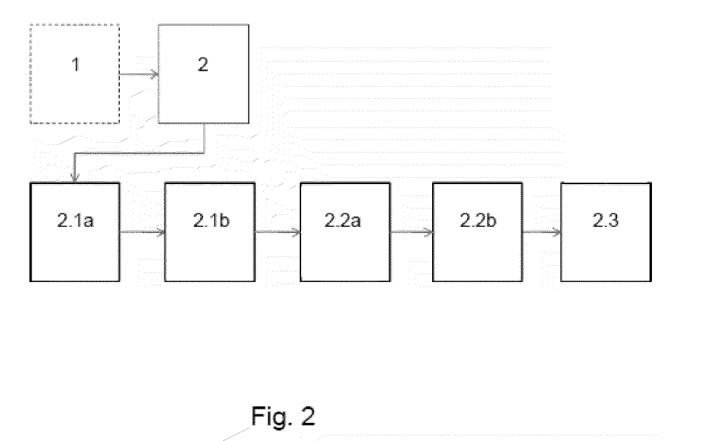

The method according to the invention for assessing candidates in voting competitions such as are generally carried out by mass media is shown in greater detail in FIGS. 1 to 4, FIG. 1 showing a matrix resulting from the voting procedure and FIG. 2 showing the sequence when carrying out the voting. In the voting procedure, a number of voters W authorised to vote determine a candidate ranking of a plurality of candidates K based on the respective voting. Unlike in known voting procedures, the voter W is allocated an individual point score G when voting which is allocated to his point account and determines his ranking. During voting, the voter W and the candidate K are thus allocated points which are determined for the candidate K from its rank and for the voter W from his rank and the rank of his selected candidate. Each voter W individually can influence voting authorisation, and thus the possibility of voting and improving the point score G, by making contact with a partner P. In particular, in this context an activity parameter A of the respective voter W in relation to at least one partner P is recorded and a voting authorisation is optionally granted. As well as the candidate ranking Kₐ to K_{z} of different candidates K, a voter ranking Wₐ₁ to Wₐₙ of voters W is determined based on the individual point score G₁ to Gₙ, resulting in a competition amongst the voters W.

During voting, the voter initially exercises his voting authorisation by voting 1, as can be seen from the sequence chart in FIG. 2. From this, a first vote status 2 is initially determined and shown for the candidate ranking 2.1a only. In the next step, the optionally altered point score G of each voter 2.1b is determined and they form on this basis a voter ranking 2.2b. This result is continually updated and displayed 2.3 to all participants.

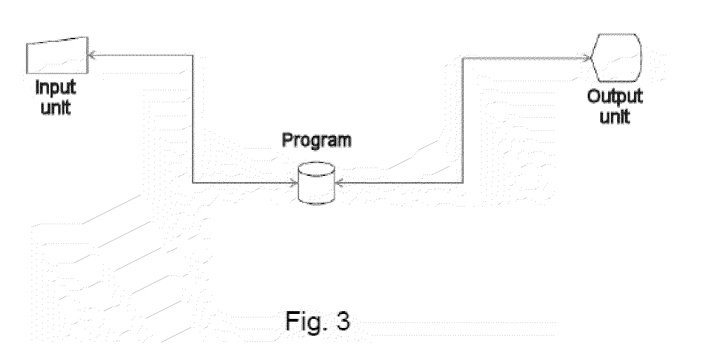

FIG. 3 shows the connection of the various components of the system for assessing candidates in voting competitions according to the method shown in FIGS. 1 and 2. Using an input unit for voting by authorised voters, these obtain the opportunity to vote at least once. Electronic telecommunication aids may for example be used for this purpose. The votes cast are processed by a centrally implemented computer program in a public computer network. In this context, the signals of a communications unit are also recorded, this unit being based on the activity parameters of the voters in connection with partner contacts which grant a voting authorisation on this basis. An output unit serves to display a candidate ranking of a plurality of candidates and the voter ranking of the voters.

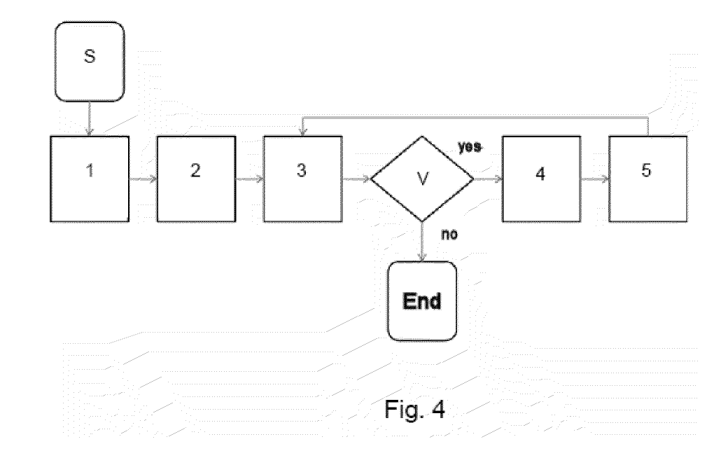

The procedure for acquiring voting rights free of charge is clarified further in FIG. 4. The procedure starts with the readiness of the voter to acquire further voting rights S, which is recorded by the system as a query. Thereupon, a profile 1 of the voter is generated for this voter based on individual data and suitable partners 2 are determined. The voter is then provided with a link 3 to partner sites, to which he is guided based on his activity, which is recorded as an activity parameter. To secure voting rights, the voter has to confirm that he has taken note of content 4, which in the case of successful participation leads to a further voting authorisation 5 and leads the voter back to an updated list of partners. Otherwise, the granting of a new voting right is refused based on lack of activity.

What is claimed is:

1. A method for assessing candidates comprising:
authorizing a plurality of voters to vote for a candidate among a plurality of candidates so as to determine a candidate ranking;
determining a weighting for one of a voter and a candidate as a function of a ranking of the candidate or voter during the voting;
allocating the weighting to the respective voter or candidate; and
changing at least one of the candidate ranking and voter ranking according to the allocated weighting.

2. The method as recited in claim 1, wherein the weighting is determined for the candidate from the ranking of the candidate and for the voter based on one of the ranking of the candidate and the ranking of the candidate selected by the voter.

3. The method as recited in claim 1, wherein the determining is performed by determining a lower weight for a higher-placed candidate than a lower-placed candidate based on the candidate rank during voting.

4. The method as recited in claim 1, wherein the determining is performed by determining a lower weight for to a higher-placed voter than a lower-placed voter based on the voter rank during voting.

5. The method as recited in claim 1, wherein the authorization to vote is based on an individual voter-based activity parameter of the voter.

6. The method as recited in claim 5, further comprising determining the individual voter-based activity parameter based on the voter making contact with an authorized partner.

7. The method as recited in claim 6, further comprising influencing the individual activity parameter based information from a virtual platform of the partner regarding at least one visit to the virtual platform by the voter.

8. The method as recited in claim 1, further comprising receiving votes from the plurality of voters using an electronic input device.

9. The method as recited in claim 1, further comprising receiving information about the voters authorized to vote from a partner.

10. The method as recited in claim 1, wherein the changing includes allocating a voter win based on the voter rank.

11. The method as recited in claim 1, further comprising collecting a plurality of authorizations to vote.

12. A system for assessing candidates comprising:
an input unit for authorized voters to cast votes;
a communications unit configured to record and establish an activity parameter of the voters;
an output unit configured to display a candidate ranking of a plurality of candidates; and
an output unit for displaying a voter ranking of voters.

13. A computer program product including a computer-readable medium having a computer program logic recorded thereon, the computer product comprising:
an input unit for authorized voters to cast votes;
a communications unit configured to record and establish an activity parameter of the voters;
an output unit configured to display a candidate ranking of a plurality of candidates; and
an output unit for displaying a voter ranking of voters.
